(19) United States
(12) Patent Application Publication
(10) Pub. No.: US 2013/0320750 A1
(43) Pub. Date: Dec. 5, 2013

(54) INTEGRATED ELECTRONIC HYDRAULIC BRAKE SYSTEM

(71) Applicant: Mando Corporation, Gyeonggi-do (KR)

(72) Inventor: Hyun Jun KIM, Gyeonggi-do (KR)

(73) Assignee: MANDO CORPORATION, Gyeonggi-do (KR)

(21) Appl. No.: 13/682,070

(22) Filed: Nov. 20, 2012

(30) Foreign Application Priority Data
Nov. 22, 2011 (KR) 10-2011-0121935

(51) Int. Cl. B60T 13/14

(52) U.S. Cl. CPC B60T 13/142
USPC 303/6.01

(57) ABSTRACT

Disclosed is an integrated electronic hydraulic brake system including an integrated hydraulic control device including a master cylinder having two hydraulic circuits to generate hydraulic pressure, a reservoir coupled to an upper part of the master cylinder to store oil, an accumulator to store a predetermined level of pressure, flow control valves and pressure reducing valves to control pressure transmitted from the accumulator to wheel cylinders installed at wheels of a vehicle, a pedal simulator connected to the master cylinder to provide reaction force of the brake pedal, and a simulation valve to control connection between the master cylinder and the pedal simulator and a power source unit including a pump to suction oil from the reservoir and discharge the suctioned oil to the accumulator to generate pressure in the accumulator and a motor to drive the pump, wherein the power source unit is configured as a separate unit to remove noise generated from the power source unit, and the integrated hydraulic control device and the power source unit are connected to each other via an external pipe.

### CROSS-REFERENCE TO RELATED APPLICATION

This application claims the benefit of Korean Patent Application No. 2011-0121935, filed on Nov. 22, 2011 in the Korean Intellectual Property Office, the disclosure of which is incorporated herein by reference.

### BACKGROUND

1. Field

Embodiments of the present invention relate to an integrated electronic hydraulic brake system including an actuator constituted by a master cylinder and a pedal simulator, electronic stability control (ESC), and hydraulic power unit (HPU) which are configured as a single unit.

2. Description of the Related Art

Recently, development of hybrid vehicles, fuel cell vehicles and electric vehicles in order to improve fuel efficiency and reduce exhaust gas has been vigorously carried out. A brake device, i.e., a brake device of a brake system for vehicles, is essentially installed in such vehicles. Here, the brake device is a device which functions to decelerate or stop a driving vehicle.

In general, brake devices of brake systems for vehicles include a vacuum brake to generate braking force using suction pressure of an engine, and a hydraulic brake to generate braking force using hydraulic pressure.

The vacuum brake exhibits large braking force at a small force through a vacuum booster using a difference between suction pressure of a vehicle engine and atmospheric pressure. That is, the vacuum brake generates output greater than force applied to a brake pedal when a driver pushes the brake pedal.

In case of such a conventional vacuum brake, suction pressure of the vehicle engine is supplied to the vacuum booster to form a vacuum, and therefore, fuel efficiency is lowered. Further, the engine is driven at all times to form the vacuum even when the vehicle is stopped.

Furthermore, a fuel cell vehicle and an electric vehicle have no engine and thus application of the conventional vacuum brake boosting driver's pedal force during braking to the fuel cell vehicle and the electric vehicle may be impossible, and a hybrid vehicle implements an idle stoppage function during stopping to improve fuel efficiency and requires introduction of a hydraulic brake.

That is, since implementation of a regenerative braking function is required to improve fuel efficiency in all vehicles, the regenerative braking function is easily implemented by employing a hydraulic brake.

In case of an electronic hydraulic brake system which is a kind of hydraulic brake, when a driver pushes a pedal, an electronic control unit senses pushing of the pedal and supplies hydraulic pressure to a master cylinder, thereby transmitting hydraulic pressure for braking to a wheel cylinder (not shown)of each wheel to generate braking force.

The electronic hydraulic brake system includes an actuator including a master cylinder, booster, reservoir, and pedal simulator, an ESC to independently control braking force of wheels, and an HPU including a motor, pump, and accumulator.

The above units constituting the electronic hydraulic brake system are separately provided and installed. As a result, it may be necessary to secure a space to install the electronic hydraulic brake system due to a limited installation space of a vehicle. In addition, the weight of the electronic hydraulic brake system is increased. For these reasons, an advanced electronic hydraulic brake system which secures safety of a vehicle during braking, improves fuel efficiency, and has proper pedal feel has been required.

Therefore, according to the above requirement, research and development on an electronic hydraulic brake system which has a simple configuration, efficiently exhibits braking force even when a failure occurs and is easily controlled are underway.

### SUMMARY

Therefore, it is an aspect of the present invention to provide an integrated electronic hydraulic brake system which has a simple configuration to improve braking safety and installation efficiency in a vehicle, thereby providing stable pedal feel during braking, and which supports regenerative braking, thereby improving fuel efficiency.

Additional aspects of the invention will be set forth in part in the description which follows and, in part, will be obvious from the description, or may be learned by practice of the invention.

In accordance with an aspect of the present invention, an integrated electronic hydraulic brake system includes an integrated hydraulic control device including a master cylinder having two hydraulic circuits to generate hydraulic pressure, a reservoir coupled to an upper part of the master cylinder to store oil, an accumulator to store a predetermined level of pressure, flow control valves and pressure reducing valves to control pressure transmitted from the accumulator to wheel cylinders installed at wheels of a vehicle, a pedal simulator connected to the master cylinder to provide reaction force of the brake pedal, and a simulation valve to control connection between the master cylinder and the pedal simulator and a power source unit including a pump to suction oil from the reservoir and discharge the suctioned oil to the accumulator to generate pressure in the accumulator and a motor to drive the pump, wherein the power source unit is configured as a separate unit to remove noise generated from the power source unit, and the integrated hydraulic control device and the power source unit are connected to each other via an external pipe.

The accumulator and the pump may be connected to each other via the external pipe, and the external pipe may have a check valve installed therein to prevent backward flow of pressure of the accumulator.

The integrated electronic hydraulic brake system may further include first and second backup channels connected between the two hydraulic circuits of the master cylinder and the wheel cylinders, a first shut off valve to control connection between the first backup channel and the master cylinder, and a second shut off valve to control connection between the second backup channel and the master cylinder, to control braking oil when the integrated electronic hydraulic brake system is abnormally operated.

The integrated electronic hydraulic brake system may further include a simulation check valve provided in a channel connected between master cylinder and the pedal simulator, wherein the simulation check valve may be configured to transmit pressure generated by pedal force of the brake pedal to the pedal simulator only through the simulation valve.

The simulation check valve may include a pipe check valve having no spring to return the remaining pressure of the pedal simulator when the pedal force of the brake pedal is released.

The integrated electronic hydraulic brake system may further include pulsation attenuators provided in channels connected between the flow control valves and pressure reducing valves to control pressure transmitted to the wheel cylinders and the wheel cylinders to minimize pressure pulsation.

### BRIEF DESCRIPTION OF THE DRAWINGS

These and/or other aspects of the invention will become apparent and more readily appreciated from the following description of the embodiments, taken in conjunction with the accompanying drawings of which:

FIG. 1 is a hydraulic circuit diagram showing a state in which an integrated electronic hydraulic brake system according to an embodiment of the present invention is not operated;

FIG. 2 is a hydraulic circuit diagram showing a state in which the integrated electronic hydraulic brake system according to the embodiment of the present invention is normally operated; and

FIG. 3 is a hydraulic circuit diagram showing a state in which the integrated electronic hydraulic brake system according to the embodiment of the present invention is abnormally operated.

### DETAILED DESCRIPTION

Reference will now be made in detail to the embodiments of the present invention, examples of which are illustrated in the accompanying drawings, wherein like reference numerals refer to like elements throughout. The terms used in the following description are terms defined taking into consideration the functions obtained in accordance with the embodiments, and the definitions of these terms should be determined based on the overall content of this specification. Therefore, the configurations disclosed in the embodiments and the drawings of the present invention are only exemplary and do not encompass the full technical spirit of the invention, and thus it will be appreciated that the embodiments may be variously modified and changed.

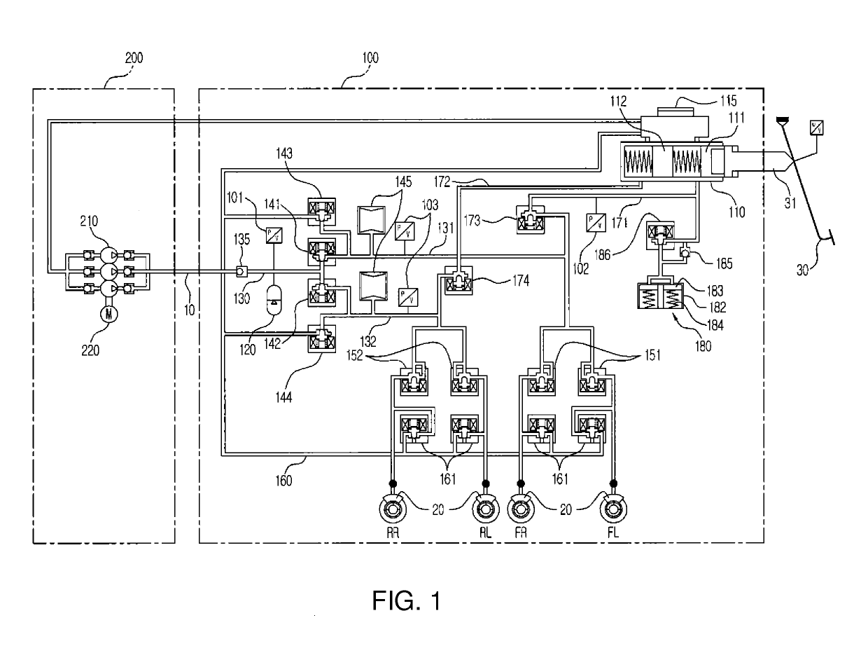

FIG. 1 is a hydraulic circuit diagram showing a state in which an integrated electronic hydraulic brake system according to an embodiment of the present invention is not operated.

The integrated electronic hydraulic brake system may include two units. Referring to FIG. 1, the integrated electronic hydraulic brake system may include an integrated hydraulic control device 100 including a brake pedal 30 manipulated by a driver during braking, a master cylinder 110, force from the brake pedal 30 is transmitted, a reservoir 115 coupled to the upper part of the master cylinder 110 to store oil, an accumulator 120 to store a predetermined level of pressure, a pedal simulator 180 connected to the master cylinder 110 to provide reaction force of the brake pedal 30, and a simulation valve 186 to control connection between the master cylinder 110 and the pedal simulator 180, and a power source unit 200 includes a pump 210 to suction oil from the reservoir 115 and discharge the suctioned oil to the accumulator 120 to generate pressure in the accumulator 120 and a motor 220 to drive the pump 210.

Also, the integrated hydraulic control device 100 may further include flow control valves 141 and 142, pressure reducing valves 143 and 144, inflow valves 151 and 152, and pressure sensors 101 and 102 to control pressure transmitted from the accumulator 120 to wheel cylinders 20 installed at wheels FL, FR, RL, and RR of a vehicle.

The integrated hydraulic control device 100 and the power source unit 200 are connected to each other via an external pipe 10. That is, the pump 210 of the power source unit 200 and the accumulator 120 of the integrated hydraulic control device 100 are connected to each other via the external pipe 10. The power source unit 200 including the pump 210 and the motor 220 is separated from the integrated hydraulic control device 100 to remove noise generated from the power source unit 200 from the integrated hydraulic control device 100. Also, the master cylinder 110, the reservoir 115, and the pedal simulator 180 are incorporated into the integrated hydraulic control device 100 as a single unit, and functions of an ESC and HPU are included in the integrated hydraulic control device 100, to reduce the weight of the integrated electronic hydraulic brake system and improve installation space of the integrated electronic hydraulic brake system.

Hereinafter, structures and functions of the components constituting the integrated electronic hydraulic brake system will be described in more detail. First, the master cylinder 110 has a first piston 111 and a second piston 112 therein to configure two hydraulic circuits, and generates hydraulic pressure according to pedal force of the brake pedal 30. A booster (not shown) may be further installed between the brake pedal 30 and the master cylinder 110. That is, when pedal force of the brake pedal 30 is boosted by the booster and is then transmitted to the master cylinder 110, the master cylinder 110 converts the force generated by the booster into hydraulic pressure and supplies braking oil stored in the master cylinder 110 to the wheel cylinders 20.

The booster is a device to boost pedal force of the brake pedal 30. The booster is well known in the art to which the present invention pertains, and therefore, a detailed description thereof will be omitted.

Meanwhile, unexplained reference numeral 31 indicates an input rod installed at the brake pedal 30 to transmit pedal force to the master cylinder 110.

The master cylinder 110 has two hydraulic circuits to secure safety when the master cylinder 110 breaks down. For example, one of the hydraulic circuits may be connected to the right front wheel FR and the left rear wheel RL, and the other may be connected to the left front wheel FL and the right rear wheel RR. Generally, however, one of the hydraulic circuits is connected to the two front wheels FL and FR, and the other is connected to the two rear wheels RL and RR. As described above, the two hydraulic circuits are independently configured to brake the vehicle even when one of the hydraulic circuits breaks down.

The reservoir 115 to store oil is installed at the upper part of the master cylinder 110. Oil discharged from the two hydraulic circuits is introduced into the wheel cylinders 20 through the lower part of the master cylinder 110.

At least one pump 210 is provided to pump the oil introduced from the reservoir 115 to generate braking pressure. At one side of the pump 210 is provided the motor 220 to provide driving force to the pump 210.

The accumulator 120 is provided at the outlet of the pump 210 to temporarily store high-pressure oil generated according to driving of the pump 210. That is, as previously described, the accumulator 120 is connected to the pump 210 via the external pipe 10. In the external pipe 10 is installed a check valve 135 to prevent backward flow of the high-pressure oil stored in the accumulator 120.

At the outlet of the accumulator 120 is provided the first pressure sensor 101 to measure oil pressure of the accumulator 120. The measured oil pressure is compared with set pressure. If the measured oil pressure is low, the pump 210 is driven to suction oil from the reservoir 115 and to supply the suctioned oil to the accumulator 120.

To supply braking oil stored in the accumulator 120 to the wheel cylinders 20 through the pump 210 and the motor 220, a connection channel 130 connected to the external pipe 10 is provided. The connection channel 130 is connected to a first inflow channel 131 connected to the front wheels FL and FR and to a second inflow channel 132 connected to the rear wheels RL and RR. In the first inflow channel 131 connected to the connection channel 130 are provided the first flow control valve 141 and the first pressure reducing valve 143 to control braking oil stored in the accumulator 120. In the second inflow channel 132 connected to the connection channel 130 are provided the second flow control valve 142 and the second pressure reducing valve 144 to control braking oil stored in the accumulator 120. That is, braking oil stored in the accumulator 120 may be supplied to the respective wheel cylinders 20 via the first inflow channel 131 and the second inflow channel 132.

The first and second flow control valves 141 and 142 and the first and second pressure reducing valves 143 and 144 are normal close type solenoid valves which are normally closed.

Meanwhile, the first inflow valves 151 are provided between the wheel cylinders 20 connected to the first inflow channel 131, and the second inflow valves 152 are provided between the wheel cylinders 20 connected to the second inflow channel 132.

The first inflow valves 151 are normal open type solenoid valves which are normally open. When a driver pushes the brake pedal 30, the first flow control valve 141 is opened to supply braking oil stored in the accumulator 120 to the wheel cylinders 20. The second inflow valves 152 may be configured to perform the same operation as the first inflow valves 151.

Also, the integrated hydraulic control device 100 may further include a return channel 160 connected between the wheel cylinders 20 and the master cylinder 110. In the return channel 160 is provided an outflow valve 161 to discharge oil from the wheel cylinders 20 to the reservoir 115. The outflow valve 161 is a normal close type solenoid valve which is normally closed.

In addition, the integrated hydraulic control device 100 may further include pulsation attenuators 145 provided in the first inflow channel 131 and the second inflow channel 132 to minimize pressure pulsation. The pulsation attenuators 145 are devices that temporarily store oil to attenuate pulsation generated between the flow control valves 141 and 142 and the pressure reducing valves 143 and 144 and the inflow valves 151 and 152. The pulsation attenuators 145 are well known in the art to which the present invention pertains, and therefore, a detailed description thereof will be omitted.

Meanwhile, unexplained reference numeral 103 indicates pressure sensors installed in the first inflow channel 131 and the second inflow channel 132 to sense pressure of braking oil supplied to the inflow channels 131 and 132. The pressure sensors 103 control the pulsation attenuators 145 so that pulsation is attenuated according to the sensed pressure of the braking oil.

According to the embodiment of the present invention, a first backup channel 171 and a second backup channel 172 may be provided between the master cylinder 110 and the wheel cylinders 20 against trouble of the integrated electronic hydraulic brake system. In the first backup channel 171 may be provided a first shut off valve 173 to open and close the first backup channel 171. In the second backup channel 172 may be provided a second shut off valve 174 to open and close the second backup channel 172. The first backup channel 171 is connected to the first inflow channel 131 via the first shut off valve 173. The second backup channel 172 is connected to the second inflow channel 132 via the second shut off valve 174. Particularly, the second pressure sensor 102 to measure oil pressure of the master cylinder 110 may be provided between the first shut off valve 173 and the master cylinder 110. When braking is performed by the driver, therefore, the backup channels 171 and 172 are shut off by the first shut off valve 173 and the second shut off valve 174, and driver's intention of braking is determined by the second pressure sensor 102.

Also, the pedal simulator 180 to generate pedal force of the brake pedal 30 is provided between the second pressure sensor 102 and the master cylinder 110.

The pedal simulator 180 includes a simulation chamber 182 to store oil discharged from the outlet of the master cylinder 110 and a simulation valve 186 provided at the inlet of the simulation chamber 182. The simulation chamber 182, including a piston 183 and an elastic member 184, is configured to have a predetermined range of displacement based on oil introduced into the simulation chamber 182. The simulation valve 186 is a normal close type solenoid valve which is normally closed. When the driver pushes the brake pedal 30, the simulation valve 186 is opened to supply braking oil to the simulation chamber 182.

Also, a simulation check valve 185 is provided between the pedal simulator 180 and the master cylinder 110, i.e. between the pedal simulator 180 and the simulation valve 186. The simulation check valve 185 is connected to the master cylinder 110. The simulation check valve 185 is configured to transmit pressure generated by pedal force of the brake pedal 30 to the pedal simulator 180 only through the simulation valve 186. The simulation check valve 185 may be a pipe check valve having no spring to return the remaining pressure of the pedal simulator 180 when the pedal force of the brake pedal 30 is released.

The integrated hydraulic control device 100 is configured in the form of a block including an electronic control unit (ECU) (not shown) electrically connected to the valves and the sensors to control the valves and the sensors, and therefore, the integrated electronic hydraulic brake system has a compact structure. That is, the integrated electronic hydraulic brake system according to the embodiment of the present invention is divided into the power source unit 200 including the pump 210 and the motor 220 and the integrated hydraulic control device 100 including the accumulator 120, the valves, the sensors, and the pedal simulator 180 to generate pedal force of the brake pedal configured as a single block. Consequently, installation space of the integrated electronic hydraulic brake system is easily secured, and the weight of the integrated electronic hydraulic brake system is reduced.

Hereinafter, the operation of the integrated electronic hydraulic brake system according to the embodiment of the present invention will be described in detail.

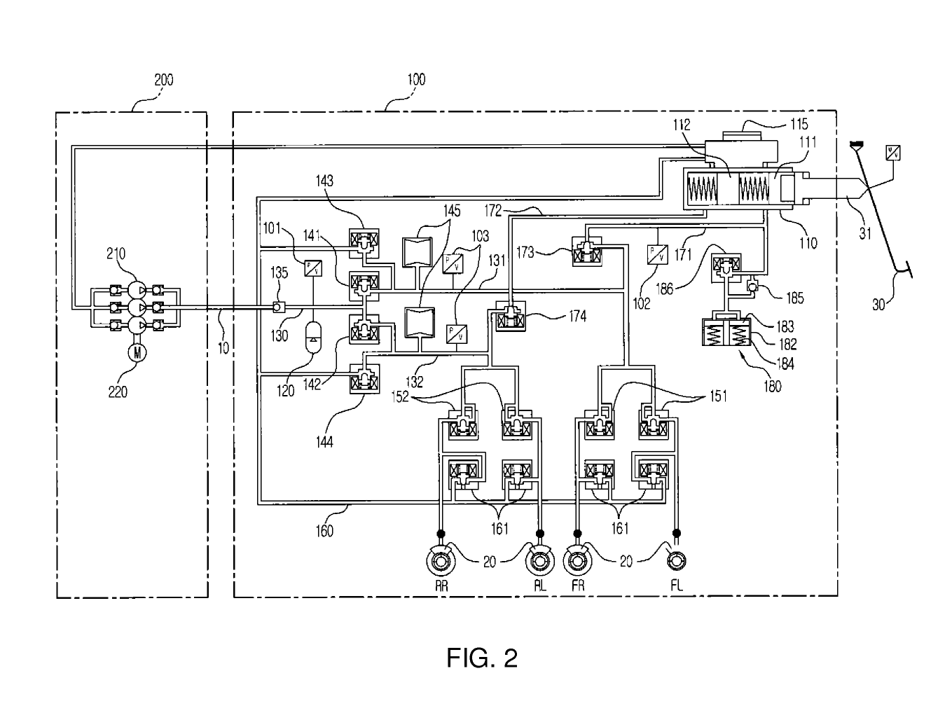

FIG. 2 is a hydraulic circuit diagram showing a state in which the integrated electronic hydraulic brake system is normally operated.

Referring to FIG. 2, when braking is commenced by a driver, an amount of braking required by the driver is sensed based on information, such as pressure of the brake pedal 30, pushed by the driver, measured by the second pressure sensor 102. A controller (not shown) may receive an amount of regenerative braking, calculate an amount of frictional braking based on the difference between the amount of braking required by the driver and the amount of regenerative braking, and detect the increase or decrease of pressure at the wheels based thereupon.

Specifically, when the driver pushes the brake pedal 30 at the initial stage of braking, the vehicle is sufficiently braked by the regenerative braking, and therefore, control may be performed not to generate the amount of frictional braking. Consequently, it may be necessary to reduce the pressure of braking oil so that hydraulic pressure applied from the brake pedal 30 to the master cylinder 10 is not transmitted to the wheel cylinders 20. At this time, the pressure reducing valves 143 and 144 are opened to discharge hydraulic pressure generated in the inflow channels 131 and 132 to the reservoir 115. As a result, no pressure is generated at the wheels RR, RL, FR, and FL, and the pressure of the brake pedal is maintained.

Afterward, a process of adjusting an amount of frictional braking based on the change of an amount of regenerative braking may be performed. The amount of regenerative braking may be changed depending upon a charge state of the battery or velocity of the vehicle. The amount of regenerative braking is abruptly reduced when the velocity of the vehicle is a predetermined value or less. To control hydraulic pressure of the wheel cylinders 20, the first flow control valve 141 may control flow of the braking oil supplied from the accumulator 120 to the first inflow channel 131. In the same manner, the second flow control valve 142 may control flow of the braking oil supplied from the accumulator 120 to the second inflow channel 132.

Afterward, there is no amount of regenerative braking, and braking may be performed based on a normal braking condition.

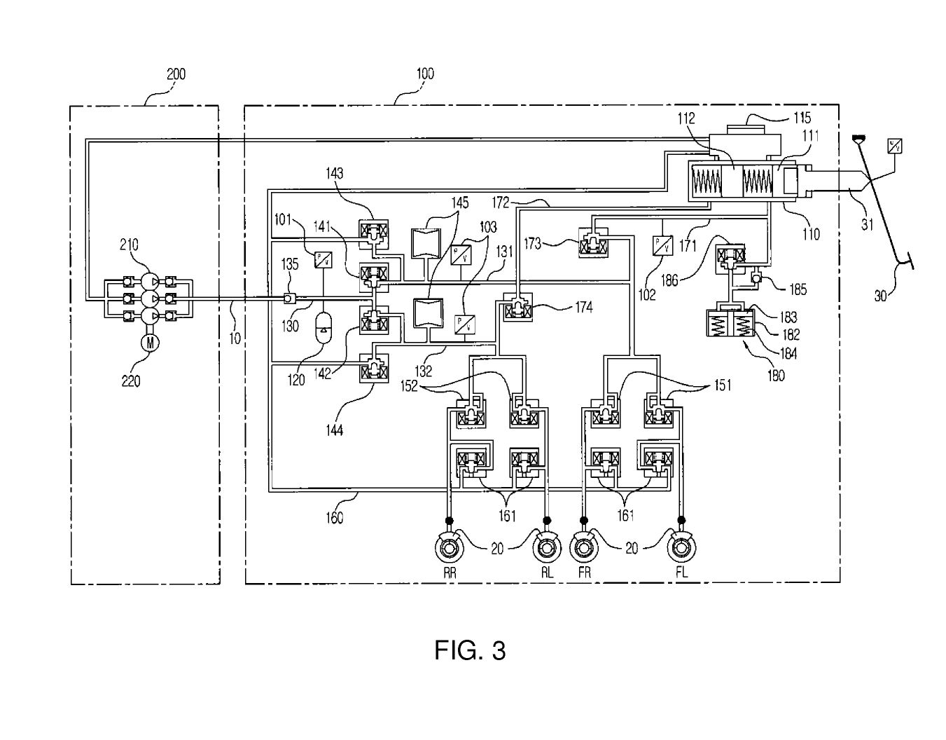

FIG. 3 is a hydraulic circuit diagram showing a state in which the integrated electronic hydraulic brake system is abnormally operated.

Referring to FIG. 3, for backup braking in a case in which the integrated electronic hydraulic brake system is abnormally operated, the first and second shut off valves 173 and 174 are opened so that braking oil from the master cylinder 110 is directly supplied to the wheel cylinders 20. At this time, the master cylinder 110 may have a less inner diameter than a conventional master cylinder to maximize mechanical braking performance based on pedal force of the brake pedal 30. That is, the master cylinder may provide sufficient braking force from braking oil stored in the master cylinder although the master cylinder 110 has a less inner diameter than the conventional master cylinder.

As is apparent from the above description, the integrated electronic hydraulic brake system according to the embodiment of the present invention has effects as follows.

First, the integrated electronic hydraulic brake system is divided into the power source unit including the pump and the motor and the integrated hydraulic control device including the accumulator, the valves, the sensors, and the pedal simulator to generate pedal force of the brake pedal configured as a single block. Consequently, installation space of the integrated electronic hydraulic brake system is easily secured, and the weight of the integrated electronic hydraulic brake system is reduced. Also, the integrated electronic hydraulic brake system is easily assembled.

Second, braking of a vehicle is achieved when the brake system malfunctions, and therefore, the integrated electronic hydraulic brake system is easily applied to electric vehicles, fuel cell vehicles and hybrid vehicles.

Third, the remaining pressure is minimized by the simulation check valve having no spring, and pedal feel transmitted to a driver is stably maintained even when pressure during braking is arbitrarily adjusted.

Fourth, the integrated electronic hydraulic brake system generates braking force required by a user regardless of whether an engine is present and whether the engine is operated, thereby contributing to improvement of fuel efficiency.

Fifth, the integrated electronic hydraulic brake system has a simpler configuration than a conventional negative pressure type booster, and does not use suction pressure of an engine unlike a vacuum brake, thereby improving fuel efficiency of a vehicle. Furthermore, the integrated electronic hydraulic brake system has a simple configuration and may thus be easily applied to a small vehicle.

Although a few embodiments of the present invention have been shown and described, it would be appreciated by those skilled in the art that changes may be made in these embodiments without departing from the principles and spirit of the invention, the scope of which is defined in the claims and their equivalents.

What is claimed is:

1. An integrated electronic hydraulic brake system to transmit hydraulic pressure generated by pedal force of a driver to wheel cylinders, comprising:
an integrated hydraulic control device comprising a master cylinder having two hydraulic circuits to generate hydraulic pressure, a reservoir coupled to an upper part of the master cylinder to store oil, an accumulator to store a predetermined level of pressure, flow control valves and pressure reducing valves to control pressure transmitted from the accumulator to wheel cylinders installed at wheels of a vehicle, a pedal simulator connected to the master cylinder to provide reaction force of the brake pedal, and a simulation valve to control connection between the master cylinder and the pedal simulator; and
a power source unit comprising a pump to suction oil from the reservoir and discharge the suctioned oil to the accumulator to generate pressure in the accumulator and a motor to drive the pump, wherein
the power source unit is configured as a separate unit to remove noise generated from the power source unit, and the integrated hydraulic control device and the power source unit are connected to each other via an external pipe.

2. The integrated electronic hydraulic brake system according to claim 1, wherein the accumulator and the pump are connected to each other via the external pipe, and the external pipe has a check valve installed therein to prevent backward flow of pressure of the accumulator.

3. The integrated electronic hydraulic brake system according to claim 1, further comprising first and second backup channels connected between the two hydraulic circuits of the master cylinder and the wheel cylinders, a first shut off valve to control connection between the first backup channel and the master cylinder, and a second shut off valve to control connection between the second backup channel and the master cylinder, to control braking oil when the integrated electronic hydraulic brake system is abnormally operated.

4. The integrated electronic hydraulic brake system according to claim 1, further comprising a simulation check valve provided in a channel connected between master cylinder and the pedal simulator, wherein the simulation check valve is configured to transmit pressure generated by pedal force of the brake pedal to the pedal simulator only through the simulation valve.

5. The integrated electronic hydraulic brake system according to claim 4, wherein the simulation check valve comprises a pipe check valve having no spring to return the remaining pressure of the pedal simulator when the pedal force of the brake pedal is released.

6. The integrated electronic hydraulic brake system according to claim 1, further comprising pulsation attenuators provided in channels connected between the flow control valves and pressure reducing valves to control pressure transmitted to the wheel cylinders and the wheel cylinders to minimize pressure pulsation.
